(19) United States
(12) Patent Application Publication
(10) Pub. No.: US 2026/0264288 A1
(43) Pub. Date: Sep. 10, 2026

(54) SURFACE DECORATION METHOD AND APPARATUS FOR DECORATING A PRINTING SUBSTRATE MADE OF CERAMIC MATERIAL

(71) Applicant: SACMI TECH S.P.A., Imola (IT)

(72) Inventor: Marco Cancellara, Imola (IT)

(21) Appl. No.: 19/491,296

(22) PCT Filed: Jul. 25, 2024
(86) PCT No.: PCT/IB2024/057198

§ 371 Date: Dec. 8, 2025

(30) Foreign Application Priority Data
Jul. 25, 2023 (IT) 102023000015615

(51) Int. Cl. B28B 11/00; B28B 11/04; B28B 17/00; B41J 3/407; B41M 5/00

(52) U.S. Cl. CPC B28B 11/001; B28B 11/048; B28B 17/0072; B41J 3/4073; B41M 5/0047; B41M 5/007

(57) ABSTRACT

A surface decoration method and apparatus of a printing substrate made of a ceramic material; the decoration apparatus comprises: a conveyor assembly to convey the printing substrate along a given path; a first printing system to create a first pattern on said printing substrate an inspection system configured to capture at least an image of said first pattern created on said printing substrate and to estimate data on the position and the orientation of said first pattern; and a control unit to operate a second printing system based on said position and orientation data and on the orientation of said first pattern so as to creates, on said printing substrate a second pattern.

### CROSS-REFERENCE TO RELATED APPLICATIONS

This Patent Application claims priority from Italian Patent Application No. 102023000015615 filed on Jul. 25, 2023, the entire disclosure of which is incorporated herein by reference.

### FIELD OF THE ART

The present invention relates to a surface decoration method and apparatus for decorating a printing substrate made of ceramic material and intended, after firing, to become a ceramic slab or tile. The present invention also relates to a method and plant for producing ceramic products, such as ceramic slabs or a ceramic tile.

### BACKGROUND OF THE INVENTION

In the field of the production of ceramic products, such as ceramic slabs or tiles, there is an ever-increasing need for ceramic products with a defined, possibly three-dimensional decoration on the visible surface, capable of reproducing, for example, the appearance of natural materials such as wood or natural stone, etc.

To create these decorations, it is known to use multi-printer decoration apparatus comprising: a conveyor device for conveying the printing substrates to be decorated along a determined path in an advancement direction through a plurality of printing stations; and a printing unit equipped with a plurality of printing devices arranged in succession along this determined path and each intended to produce a relative pattern on the printing substrate so that the various patterns together define the desired decoration.

Typically, these decoration apparatuses comprise at least one inkjet printing device operable from a control unit to apply inks or adhesive materials in liquid form to the ceramic substrate so as to achieve a certain pattern, as the substrate itself advances along the determined path, and one or more digital deposition assemblies for applying solid or liquid decoration material, e.g. ceramic grit or inks or a combination thereof, to the printing substrate so as to form a further pattern on the substrate itself at least partially superimposed on the pattern formed by the inkjet printing device. In this way, by combining the patterns created by the various printing devices of the decorating apparatus, different aesthetic and functional effects will be achieved, depending on the determined decoration to be implemented on the printing substrate.

It goes without saying that in order to achieve the desired decoration and guarantee the appropriate quality standards, it is necessary that the various patterns created by the various printing devices are coordinated with each other in order to be combined appropriately and form the desired decoration. In order to ensure such coordination between the decorations or patterns produced by the various printing devices, it is necessary to control the drive of the various printing devices appropriately, taking into account the distance between them, their conveying speed, but also the dimensional and shape characteristics of the printing substrate. The coordination between the various patterns is also clearly influenced by the position and orientation in which the printing substrate arrives at the various printing devices.

It is precisely for this reason that the well-known multi-printer decorating devices generally comprise mechanical centring systems, placed upstream of the printing devices along the aforementioned determined path and consisting of fixed guides configured to centre the printing substrate on the conveyor device and to keep it in that position throughout their movement through the various printing stations.

Decoration apparatuses made in this way, however, have certain drawbacks, mainly related to the presence of the aforementioned mechanical centring systems, which increase the mechanical complication and bulk of the decoration apparatus and do not always guarantee the desired results.

More specifically, in some cases, for example when decorating on uncoated printing substrates, the action of the mechanical centring devices, which act by contact, risks damaging the substrates, which will consequently have to be discarded with all the associated economic losses.

Furthermore, mechanical centring devices are generally dimensioned to act on certain types of printing substrates, in particular having certain maximum dimensions. Hence, in the case of decoration apparatuses intended to handle printing substrates of even very different sizes (an increasingly frequent occurrence given the growing market demand for ceramic products of different shapes and sizes), mechanical centring devices risk not being suitable for all the possible formats that the decoration apparatus is intended to handle. This requires time-consuming adjustment or adaptation of the mechanical centring devices every time the format of the printing substrates to be processed is changed, or, even worse, the need to replace the mechanical centring devices every time the format of the printing substrates to be processed is changed, resulting in downtime at every format change and hence a drop in the productivity of the decoration system.

It is understood that this drawback is all the more pronounced the greater the number of ceramic substrate formats that the decoration apparatus is intended to treat and the more often the decoration apparatus itself is intended to change the format of the treated ceramic substrate.

Alternatively, to overcome the aforementioned problems, decoration devices without mechanical centring systems have been developed, but equipped with cameras or scanners placed upstream of the printing unit to detect the position and orientation of the printing substrate being fed to the printing unit so as to vary (rotate and/or translate) the pattern printed by the various printing devices taking into account this actual position and orientation of the substrate.

However, even these types of devices have several drawbacks, including the inability to operate with the same level of precision and accuracy guaranteed by modern printing devices due to the inherent limitations of the detection systems used, which require complex and slow image combination operations to reconstruct the profile of the substrate. In addition, it is often necessary to detect a large part of the edges of the printing substrate (even the edges longitudinal to the conveying direction of the substrate itself) in order to obtain an accurate measurement, which increases processing time.

In addition, the detection systems of known devices are generally configured to detect/reconstruct the perimeter (i.e. edge) profile of the printing substrate, whereby any irregularities in the substrate edge can lead to imprecision and inaccuracy in the determination of the position and orientation of the substrate and thus in the subsequent operation of the printing devices.

Patent WO2023/047328, by the same applicant, describes a decoration apparatus which provides for making an at least partially raised decoration on a printing substrate, detecting it by means of a detection system of a known type, and controlling, accordingly, a further printing device capable of making an at least partially raised image on the decoration.

The purpose of the present invention is to provide a method and a surface decoration apparatus for decorating a ceramic substrate, which overcome, at least in part, the disadvantages of the prior art, allowing the decoration of ceramic substrates of different shapes and sizes in a simpler, quicker and more efficient manner with the same quality of the final decoration.

### SUMMARY

In accordance with the present invention, a surface decoration method and apparatus are proposed for creating a defined decoration on a printing substrate made of ceramic material, according to what is claimed in the appended independent claims, and preferably, in any of the claims dependent directly or indirectly on the said independent claims.

The claims describe preferred embodiments of the present invention forming an integral part of the present description.

### BRIEF DESCRIPTION OF THE DRAWINGS

The invention will now be described with reference to the accompanying drawings, which illustrate some non-limiting embodiments, wherein:

FIG. 1 is a schematic representation of a surface decoration apparatus adapted to decorate printing substrates made of ceramic material in accordance with a first embodiment of the present invention;

FIG. 2 is a schematic representation of a printing substrate decoration apparatus adapted to decorate printing substrates made of ceramic material in accordance with a further embodiment of the present invention;

FIG. 3 is a perspective view of an inspection device that is part of the surface decoration apparatus of FIGS. 1 and 2 in accordance with an embodiment of the invention; and

FIG. 4 is a schematic representation of an apparatus for making ceramic products, such as ceramic slabs and tiles, which comprises the decoration apparatus of FIG. 1 or FIG. 2.

### DETAILED DESCRIPTION

In the appended figures, a surface decoration apparatus for producing a defined decoration on a printing substrate 2 made of ceramic material is referred to as number 1.

The printing substrate 2 made of ceramic material has at least one surface 3 (in use, oriented upwards) on which the defined decoration is to be formed, a further surface (in use, oriented downwards and not visible in the appended figures) parallel to and opposite the surface 3 and at least four edges connecting the two surfaces.

Typically but not necessarily, the printing substrate 2 is substantially shapes (in plan view) like a quadrilateral. More precisely, the printing substrate 2 is substantially shaped like a parallelepiped. In some specific and non-limiting cases, the printing substrate 2 has a substantially rectangular shape (in plan view).

Advantageously, the surface decoration apparatus 1 comprises: a conveyor assembly 4 to convey the printing substrate 2, advantageously but not necessarily with a random orientation, along a given path P, in a conveying direction A, through at least two printing stations 5, 6, arranged in succession along the given path P and an inspection station 7, arranged upstream of the printing station 6 along the given path P and advantageously downstream of the printing station 5; a printing system 8, arranged at the printing station 5 and configured to create a first pattern M1 on the printing substrate 2, which, in use, is conveyed through this printing station 5; a further printing system 9, arranged at the printing station 6; and an inspection system 10, arranged above the conveyor assembly 4 at the inspection station 7.

Advantageously but not necessarily, the conveyor assembly 4 defines a movement plane 11 on which the printing substrate 2 lies in support and which is adapted to support this printing substrate 2 as it advances along the given path P; which movement plane 11 extends along (in particular, along at least part of) the given path P.

According to some advantageous but non-limiting embodiments, the conveyor assembly 4 comprises a plurality of conveyors 12 arranged in succession and aligned with each other along the given path P. In particular, the movement plane 11 advantageously but not necessarily comprises the upper surface of the above-mentioned plurality of conveyors 12.

Advantageously, the inspection system 10 is configured (i.e., programmed) to acquire at least one image of the aforementioned pattern M1 created on the printing substrate 2 by the printing system 8 and to estimate (i.e., calculate) data on the position and orientation of the pattern M1 created on the printing substrate 2. More specifically, advantageously but not necessarily (as will be further explained below), the inspection system 10 is configured to determine the X and Y coordinates of the pattern M1 made on the printing substrate 2 with respect to a fixed reference system that is integral with the inspection system 10 and its orientation θ with respect to the conveying direction A, i.e. to determine the coordinates (X, Y and θ) spatially with respect to a fixed reference system that is integral with the inspection system 10.

Even more advantageously but not necessarily, the inspection System 10 comprises at least one CIS (Contact Image Sensor) vision sensor 14. Advantageously, the use of this type of CIS (Contact Image Sensor) vision sensor 14 eliminates the need to combine the images acquired with a plurality of linear cameras and makes it possible to easily acquire an image of the pattern M1 with a resolution, which is comparable to the precision with which print systems 8 and 9 operate, resulting in an improvement in the quality of the decoration created on the printing substrate 2.

According to some advantageous but non-limiting embodiments, the CIS vision sensor 14 has a resolution of at least about 180 dpi; more advantageously, at least about 200 dpi; even more advantageously, at least about 500 dpi; more particularly, about 600 dpi.

Alternatively or in combination, according to other advantageous but non-limiting embodiments, the inspection system 10 comprises at least one CCD (Charged Coupled Device) sensor 14 or at least one CMOS (Complementary Metal-Oxide semiconductor) sensor 14.

It is understood that, according to other advantageous but non-limiting embodiments, the inspection system 10 could comprise any other detector (i.e. sensor) capable of guaranteeing the required levels of accuracy.

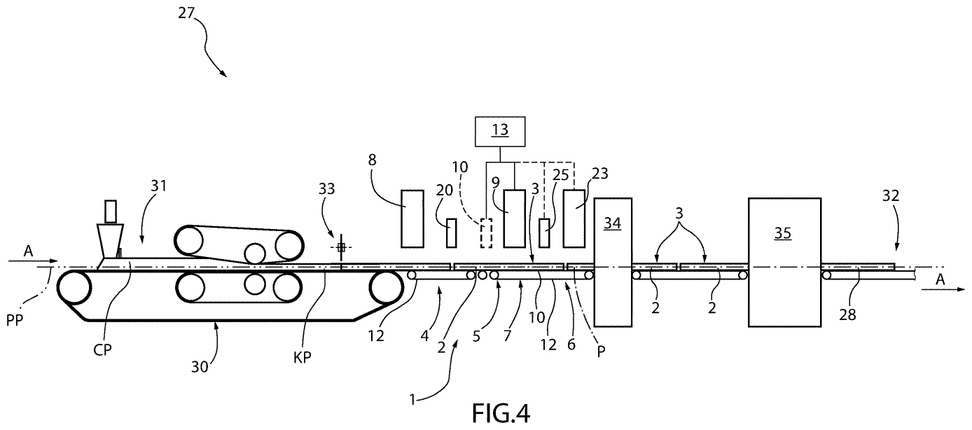

Advantageously, the decoration apparatus 1 further comprises a control unit 13 (see, for example, FIG. 4) configured to operate the printing system 9 based on the position and orientation data of the first pattern M1, so that the second printing system 9 creates, on the printing substrate 2, a second manipulated pattern M2 to define together with the first pattern M1 the aforementioned defined decoration; in particular, this second manipulated pattern M2 is configured and arranged with respect to the first pattern M1 to define together the aforementioned defined decoration.

More advantageously but not necessarily, the control unit 13 is configured (i.e., programmed) to rotate and/or translate a second reference pattern (not illustrated in the accompanying figures), based on the aforementioned data estimated by the inspection system 10, so as to obtain the second manipulated pattern M2 to control the printing system 9 so that it applies this second manipulated pattern M2 on the printing substrate 2, thereby ensuring that the pattern M2 created by the printing system 9 is coordinated with the pattern M1 actually created by the printing system 8.

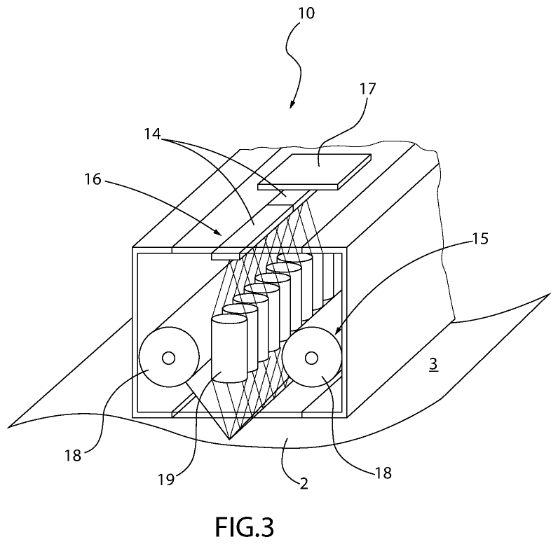

According to some advantageous but non-limiting embodiments, such as for example the one illustrated in FIG. 3, the inspection system 10 comprises: a lighting unit 15 configured to emit a light beam towards at least an inspection area of said conveyor assembly 4, in particular of the movement plane 11, so as to light the first pattern M1 created on the printing substrate 2, when the latter goes through the inspection station 7; an acquisition unit 16, which is configured to acquire images of the first pattern M1 created on the printing substrate 2; and a processing unit 17 (schematically illustrated in FIG. 3) Which receives the images acquired by the acquisition unit 16 and, based on these images, estimates said position and orientation data of the first pattern M1 created on the printing substrate 2.

Advantageously, but not necessarily, the inspection unit 16 comprises (in particular, coincides with) the above-mentioned at least one CIS vision sensor 14 or the above-mentioned at least one CCD (Charged Coupled Device) sensor 14 or the above-mentioned at least one CMOS (Complementary Metal-Oxide Semiconductor) sensor 14 (e.g., in the non-limiting embodiment illustrated in FIG. 3, the acquisition unit 16 comprises a plurality of sensors 14).

In particular, the processing unit 17 is configured to determine, on the basis of the images acquired by the acquisition unit 16, the position of a plurality of points of the first pattern M1 (in particular, forming the first pattern M1) and the orientation of this first pattern M1 with respect to the conveying direction A so as to derive the spatial coordinates (X, Y, θ) of this plurality of points with respect to a fixed reference system.

More specifically, advantageously but not necessarily, the processing unit 17 is configured to determine the coordinates X and Y in a fixed reference system; in particular, with respect to the reference system of the inspection system 10.

According to certain advantageous but non-limiting embodiments, the processing unit 17 is configured to derive the spatial coordinates (X, Y, θ) with respect to a fixed reference system by analysing significant portions of the images acquired by the inspection system 10 (in particular by the acquisition unit 16); advantageously but not necessarily, these significant portions are chosen from portions having significant geometries, for example edge portions, or portions containing discontinuities or otherwise areas of high contrast.

Alternatively or additionally, according to other advantageous but non-limiting embodiments, the processing unit 17 is configured to derive the spatial coordinates X, Y, θ of these portions with respect to a fixed reference system by comparing an image file sent by the printing device 8 to the inspection system 10 with the images acquired by the inspection system (in particular, by the acquisition unit 16).

In further detail (advantageously but not necessarily), in the present discussion the coordinates X and Y of a point are understood to be the coordinates on a reference system that lies on a plane parallel to or coincident with the movement plane 11 on which the printing substrate 2 lies while, in use, being conveyed along the given path P. In particular, the axis Y (i.e. the Y-coordinate axis) is substantially parallel to the direction A (and the axis X—i.e. the X-coordinate axis—is substantially perpendicular to the direction A); even more advantageously but not necessarily, the X-Y coordinate plane of the fixed reference system is the plane on which the surface 3 to be decorated lies. More specifically, this reference system is the reference system of the inspection system 10 (in particular, it is integral with the inspection system 10).

Whereas “orientation θ2 of the first pattern M1 with respect to the conveying direction A means the angle that this first pattern M1 (in particular, the aforementioned plurality of points of the first pattern M1) forms with the conveying direction A.

According to some non-limiting embodiments, the processing unit 17 is able to process such data by applying image analysis techniques, known in themselves, based on the detection of the contours of printed graphics, in this case of the pattern M1.

Even more advantageously, but not necessarily, the processing unit 17 is configured to inspect one or more portions of the images acquired by the inspection system 10 (in particular, by the acquisition unit 16) until a portion is identified within which a number of points with sufficient information content to allow the determination the aforementioned position and orientation data, for example edge points or high contrast points, are present.

Advantageously, but not necessarily, the lighting unit 15 comprises a plurality of light sources 18, in the illustrated case two LED bars extending crosswise to the conveying direction A above the conveyor assembly 4, and are configured to emit a plurality of light beams towards the conveyor assembly 4 and a plurality of collimation lenses 19 to collimate the light beams towards the aforementioned inspection area, which has a main extension dimension substantially crosswise to the conveying direction A; in particular, it comprises (more particularly, is) a strip of the aforementioned movement plane 11 crosswise to the conveying direction A.

According to some advantageous but non-limiting embodiments, the surface decoration apparatus 1 also comprises a detection device 20 (only schematically illustrated in FIG. 4), which is arranged upstream of the inspection station 7 along the given path P, is configured to detect the presence of the printing substrate 2 and is connected to the inspection system 10 so as to transmit an activation (or trigger) signal to the inspection system 10 every time it detects a printing substrate 2.

According to some advantageous but non-limiting embodiments, this detection device 20 comprises (in particular, is) a (per se known) sensor, e.g. an encoder or a photocell, configured to detect the front end of a printing substrate 2 being conveyed on the conveyor assembly 4 towards the inspection system 10 and to generate and transmit the aforementioned activation (or trigger) signal. In this way, the inspection system 10 will only be in use when necessary.

According to some advantageous but non-limiting embodiments, such as the one schematically illustrated in FIG. 4, this detection system 20 is placed upstream of the printing system 8 along the given path P. According to some advantageous but non-limiting embodiments, the detection system 20 is placed immediately upstream of the inspection system 10, in other words, it is placed between the printing system 8 and the inspection system 10 along the aforementioned given path P.

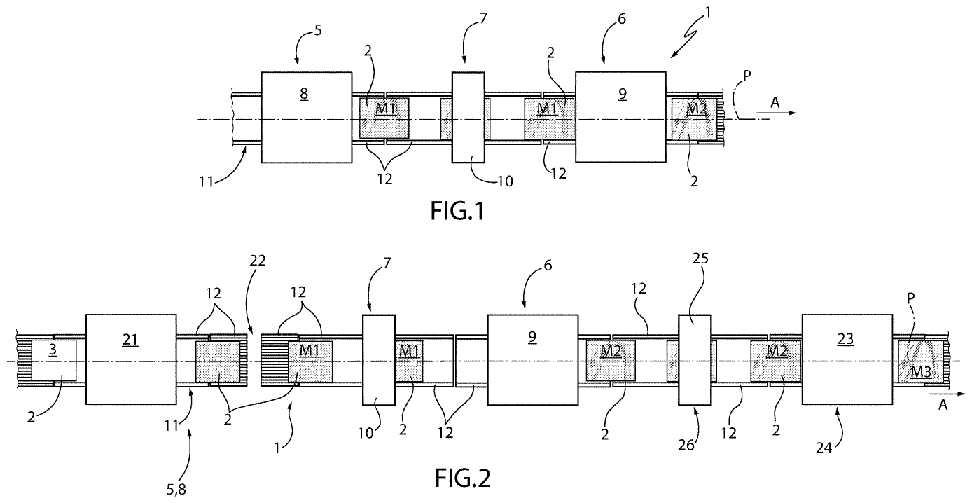

According to certain advantageous but non-limiting embodiments, such as the one illustrated in FIG. 1, the printing system 5 comprises (in particular, is) an inkjet digital printer that is configured to apply a first material onto the printing substrate 2 thereby defining the first pattern M1; and the printing system 9 comprises (in particular, is) a digital deposition assembly that is configured to deposit, in a controlled manner, a second material onto the printing substrate 2 according to (in particular, following; i.e., defining) the second manipulated pattern M2, so that the first pattern M1 and the second manipulated pattern M2 together define the aforementioned defined decoration.

More advantageously but not necessarily, the printing system 9 is configured to apply the second material at least partially over the first material, the second M2 pattern being manipulated at least partially over the first M1 pattern.

According to some advantageous but non-limiting embodiments not illustrated, the above-mentioned storage unit comprises (in particular, is formed by): a container to contain the above-mentioned second material, an outlet, the longitudinal extent of which is transverse (in particular, perpendicular) to the direction A of advancement, and a plurality of distribution elements arranged in succession along the outlet and each independently operable from the others to allow the passage of the above-mentioned second material through at least one zone of the outlet.

Even more advantageously but not necessarily, the deposition assembly is as described in patent application WO2009118611 (by the same applicant) and/or patent IT1314623.

Advantageously but not necessarily, the first material comprises (in particular, is) a liquid material; more particularly, a liquid material comprising (i.e. coinciding with) an adhesive substance and/or an ink; whereas the second material comprises (in particular, is) a solid material; more particularly, a solid material comprising (i.e. coinciding with) a ceramic powder and/or grit.

Alternatively, according to certain non-illustrated and non-limiting embodiments, the printing system 8 comprises (in particular, is) a digital deposit assembly, advantageously of the type described above, which is configured to deposit in a controlled manner a first material on the printing substrate 2 according to (in particular, following; i.e., defining) the first pattern M1 while the second printing system 9 comprises (in particular, is) an inkjet digital printer configured to apply a second material on the printing substrate 2 thereby defining, the second manipulated pattern M2. Advantageously but not necessarily, in this case, the first material comprises (in particular, is) a solid material; in particular, ceramic powder and/or grit, while the second material is a liquid material, e.g. a fixative.

According to other non-limiting embodiments, such as, for example, the one illustrated in FIG. 2, the printing system 8 comprises (in particular, is formed by) a deposition assembly 21, advantageously but not necessarily of the type described above, which is configured to deposit in a controlled manner a first material (in particular, a first liquid material; more particularly, a first liquid material comprising adhesive material) on the printing substrate 2 and a spraying application unit 22 (only schematically depicted in FIG. 2), placed downstream of the deposition assembly 21 along the given path P, for spraying a second material (in particular, a second liquid material; more particularly, comprising enamel) onto the printing substrate 2 so that this, in contact with the first material, defines the first pattern M1; while the printing system 9 comprises (in particular, is formed by) a further deposition assembly, advantageously but not necessarily of the type described above, configured to deposit in a controlled manner a third material (in particular, a solid material; more particularly, a solid material comprising ceramic powder and/or a grit) onto the printing substrate 2, or an inkjet digital printer configured to apply a third material (in particular, comprising a third liquid material; more particularly, a third liquid material comprising at least one ink) onto the printing substrate 2 according to (in particular, following) the second manipulated pattern M2.

Advantageously but not necessarily, the spraying application unit 22 comprises (in particular, is) an airless booth. More advantageously but not necessarily, in this case, the first material and the second material are such (in particular, are chosen so) as to interact with each other, to define the first pattern M1 having at least one bas-relief part (see FIG. 2).

According to some advantageous but non-limiting embodiments, such as the one illustrated in FIG. 2, the surface decoration apparatus 1 also comprises a further printing system 23, arranged at a further printing station 24 downstream of the printing station 6 along the given path P. Advantageously but not necessarily, this further printing system 23 comprises (in particular, is) a further deposition assembly configured to deposit a further material (which more advantageously but not necessarily comprises solid material, e.g. granular ceramic material or ceramic powder) on the printing substrate 2 according to a further pattern M3 so as to define together with the first pattern M1 and at least the second manipulated pattern M2 the above defined decoration.

In this case (i.e. when the surface decoration apparatus 1 also comprises a further printing system 23), advantageously but not necessarily, the control unit 13 is configured to also control this further printing system 23, based on the position and orientation data of the first pattern M1, SO that the further printing system 23 creates/affixes on the printing substrate the above-mentioned further manipulated pattern M3 configured and arranged with respect to the first pattern M1 and the second manipulated pattern M2 to define therewith the above-mentioned defined decoration.

Alternatively or additionally, in this case (i.e. when the surface decoration apparatus 1 further comprises a further printing system 23), a further inspection system 25 is also provided which is arranged at a further inspection station 26, placed upstream of the printing station 24 and downstream of the printing station 6 along said given path P and configured (i.e. programmed) to acquire at least one image of a combined decoration, comprising (in particular, formed by) the first pattern M1 and the second manipulated pattern M2 made on the printing substrate 2 by the printing systems 8 and 9, and to evaluate data on the position and orientation of this combined decoration. The control unit 13 is, in this case, configured to actuate the printing system 23 also on the basis of such data on the position and orientation of the combined decoration so that the printing system 23 creates/affixes on the printing substrate 2 the above-mentioned further manipulated pattern M3 configured and arranged with respect to the first pattern M1 and the second manipulated pattern M2 so as to define, together therewith (with the first pattern M1 and the second manipulated pattern M2) the defined decoration.

Advantageously but not necessarily, the additional inspection system 25 is configured to detect the above-mentioned data on the combined decoration; i.e., at least the X and Y coordinates of the combined decoration created on the printing substrate 2 and its orientation with respect to the conveying direction A.

According to some advantageous but non-limiting embodiments, again, the additional inspection system 25 comprises at least one CIS (Contact Image Sensor) vision sensor 14 or at least one CCD (Charged Coupled Device) sensor 14 or at least one CMOS (Complementary Metal-Oxide Semiconductor) sensor 14.

Even more advantageously but not necessarily, when provided, this further inspection system 25 is similar to the inspection system 10, i.e. comprising: a lighting unit 15 for emitting a beam of light towards at least one inspection area of the conveyor assembly 4, in particular of the movement plane 11, so as to illuminate the combined decoration, comprising the first pattern M1 and the second manipulated pattern M2, when the printing substrate 2 passes through the inspection station 26; an acquisition unit 16 which (according to certain advantageous but non-limiting embodiments comprises—in particular, coincides with—the aforementioned at least one CIS vision sensor 14 or with the aforementioned CCD sensor 14 or with the aforementioned CMOS sensor 14, and which) is configured to acquire images of the combined decoration created on the printing substrate 2; and a processing unit 17 (schematically illustrated in FIG. 3) which receives the images acquired by the acquisition unit 16 and, the basis of said images, estimates the aforementioned data on the position and orientation of the combined decoration with respect to a fixed reference system; in particular with respect to the reference system of the inspection system 25.

It is understood that according to other advantageous but non-limiting embodiments, the surface decoration apparatus 1 could comprise a different (in particular, larger) number of printing systems and possibly also further inspection systems, advantageously but not necessarily analogous to the inspection systems 10 and 25, configured to detect such data on the position and orientation of what (i.e. the pattern or the combined decoration comprising several patterns) has already been created on the printing substrate 2 by the previous printing systems 8, 9, 23 and to transfer such data to the control unit 13 to control accordingly the operation of the various subsequent printing systems or even for safety purposes.

In accordance with a second aspect of the present invention (FIG. 4), a plant 27 is provided for manufacturing ceramic products 28; in particular, ceramic slabs or tiles.

The plant 27 comprises the surface decoration apparatus 1 described above; a compacting machine 29 for compacting a powder material CP comprising ceramic powder so as to obtain a compacted powder layer KP; and a conveyor 30 (which according to some advantageous but non-limiting embodiments is part of the conveyor assembly 4 and according to others is placed upstream of the conveyor assembly 4 along the same given path P) which is adapted to convey (in a substantially continuous manner) the powdered material CP along a path PP (of which the path P is a section) from an inlet station 31 to the compacting machine 29 and the compacted powder layer KP (also along the path PP) from the compacting machine 29 to the surface decoration apparatus 1 (and to an outlet station 32). In particular, the compacting machine 29 and the surface decoration apparatus 1 are arranged along the path PP between the inlet station 31 and the outlet station 32. More specifically, the surface decoration apparatus 1 is arranged downstream of the compacting machine 28 along the route PP

In particular, the aforementioned printing substrate 2 comprises (at least) a portion of the compacted powder layer KP.

According to certain non-limiting embodiments, the plant 27 comprises at least one cutting unit 33 (only schematically illustrated in FIG. 4) for transversely cutting the compacted powder layer KP in order to obtain a plurality of printing substrates 2. In particular, the cutting unit 33 is arranged along the path PP (more specifically, downstream of the compacting machine 29 and upstream of the surface decoration apparatus 1). Advantageously, but not necessarily, the conveyor 30 is capable of feeding the compacted powder layer KP to the cutting unit 33 and transporting the printing substrate 2 downstream of the cutting unit 33 to the inlet of the surface decoration apparatus 1; in particular, to the conveyors 12 of the conveyor assembly 4.

According to certain non-limiting embodiments, the plant 27 further comprises a dryer 34 arranged along the path PP downstream of the compacting machine 29 (more precisely, downstream of the cutting unit 33) and downstream of the surface decoration apparatus 1. According to other advantageous but non-limiting embodiments not illustrated, the dryer 34 is placed upstream of the surface decoration apparatus 1.

According to certain non-limiting embodiments, the plant 27 also comprises at least one firing furnace 35 for sintering the printing substrate 2 to obtain the ceramic product 28. In particular, the firing furnace 35 is arranged along the path PP downstream of the surface decoration apparatus 2.

According to some non-limiting embodiments not illustrated, the plant 27 does not comprise the compacting machine 29 and the cutting unit 33 but does comprise a conventional tile pressing machine (of the known type). Typically, such a pressing machine is provided with a vertical-axis hydraulic pressing device adapted to press powder ceramic material so as to directly obtain individual slabs (which do not require cutting) of pressed material.

In accordance with a third aspect of the present invention, a surface decoration method is provided for producing a defined decoration on a printing substrate 2 made of ceramic material which is advantageously but not necessarily implemented with the surface decoration apparatus 1 of the present invention.

Advantageously, the decorating method comprises: a conveying step, during which a conveyor assembly 4 conveys at least one printing substrate 2 along a given path P, in a conveying direction A, through a printing station 5, at least one further printing station 6, located downstream of the printing station 5 along the given path P, and an inspection station 7, located upstream of the printing station 6 and advantageously downstream of the printing station 5 along the given path P; a first printing step, during which a printing system 8, advantageously but not necessarily made in accordance with one of the embodiments described above in relation to the surface decoration apparatus 1, arranged at the printing station 5, creates a first pattern M1 on the printing substrate 2, while this is conveyed at the printing station 5; an inspection step, (at least partially) subsequent to the first printing step and simultaneous with the conveying step, during which an inspection system 10 arranged at the inspection station 7 acquires at least one image of the first pattern M1 made on the printing substrate 2 and estimates data on the position and orientation of the first pattern M1.

Advantageously, but not necessarily, the inspection system 10 used in this inspection step is made in accordance with any of the embodiments described above in relation to the surface decoration apparatus 1. Even more advantageously but not necessarily, as mentioned in relation to the surface decoration apparatus 1, this inspection system 10 comprises at least a CIS (Contact Image Sensor) vision sensor 14 or the aforementioned CCD (Charged Coupled Device) sensor 14 or CMOS (Complementary Metal-Oxide Semiconductor) sensor 14.

According to some advantageous but non-limiting embodiments, the inspection step comprises: a lighting sub-step, during which a lighting unit 15 emits a light beam towards at least an inspection area of the conveyor assembly 4 and lights the first pattern M1 created on the printing substrate 2 during the first printing step; an image acquiring step, during which an acquisition unit 16 (advantageously but not necessarily comprising—in particular, coinciding with—the aforementioned CIS vision sensor 14 or the aforementioned Charged Coupled Device (CCD) sensor 14 or the Complementary Metal-Oxide Semiconductor (CMOS) sensor 14) acquires images of the first pattern M1 created on the printing substrate 2 as it is conveyed along the given path P; and a processing sub-step, during which a processing unit 17 receives the images acquired by the acquisition unit 16 and, on the basis of these images, estimates the position of a plurality of points of the first pattern M1 with respect to a fixed reference system and the orientation of the first pattern M1 relative to the conveying direction A, in particular on the basis of the position of this plurality of points.

According to certain advantageous but non-limiting embodiments, during this lighting sub-step a plurality of light sources 18 emit beams of light towards the conveyor assembly 4 and a plurality of collimating lenses 19, advantageously but not necessarily of the type described above, collimate such light towards an inspection area of the conveyor assembly 4.

Advantageously, the surface decoration method also comprises: at least a second printing step, (at least partially) subsequent to the inspection step, during which a printing system 9, arranged at the printing station 6, produces a second manipulated pattern M2 on the printing substrate 2; and a controlling step, (at least partially) subsequent to the inspection step and simultaneous with the second printing step, during which a control unit 13 controls the activation of the printing system 9 on the basis of data on the position and orientation of the first pattern M1 so that the printing system 9 creates on the printing substrate 2 the second manipulated pattern M2 configured and arranged with respect to the first pattern MI so as to define together with the at least first pattern M1 the defined decoration.

In detail, advantageously but not necessarily, this controlling step comprises a manipulation sub-step, during which the control unit 13 rotates and/or translates a second reference pattern M2 based on the aforementioned position and orientation data of the first pattern M1 and obtains the second manipulated pattern M1.

According to some advantageous but non-limiting embodiments, the inspection step comprises: a triggering step, (at least partially) preceding the inspection step, during which a detection device 20, which is placed upstream of the inspection station 7 along the given path P, detects the presence of the printing substrate 2, e.g. detects the feed edge of the printing substrate 2 being fed (i.e., input) to the inspection station 7 and transmits an activation signal (i.e., a trigger signal) to the inspection system 10. More advantageously but not necessarily, the inspection system 10, once actuated by the above-mentioned trigger signal, acquires images of the first pattern M1 or of the combined pattern (comprising the first pattern M1 and the second manipulated pattern M2) with a certain acquisition frequency, which is a function of the conveying speed of the conveyor assembly 4, and with a suitable resolution such as to guarantee the estimate of the position and orientation with an accuracy with respect to the above-mentioned fixed reference system (in particular, to the reference system of the inspection system 10) of at least ±0.6 mm for the coordinates X, Y and of ±0.1° for the orientation θ with respect to the conveying direction A.

According to some advantageous but non-limiting embodiments, the decoration method comprises: a further printing step, during which a third printing system 23, advantageously but not necessarily made in accordance with one of the embodiments described above, applies a further manipulated pattern M3 onto the printing substrate 2. In this case, during the controlling step, the control unit 13 controls (i.e. commands) the activation of the printing system 23, based on the position and orientation data of the first pattern M1, so that the printing system 23 creates, on the printing substrate 2, the further manipulated pattern M3 configured and arranged, relative to the first pattern M1 and the second manipulated pattern M2, so as to define, together therewith (i.e. with the first pattern M1 and the second manipulated pattern M2), the defined decoration.

According to some advantageous but non-limiting embodiments, in this case (i.e. when at least a third printing step is envisaged) the surface decoration method comprises: a further inspection step, (at least partially) preceding the third printing step and following the second printing step, during which a further inspection device 25, advantageously but not necessarily analogous to the inspection device 10, arranged downstream of the printing system 9 along the defined path P, acquires at least one image of a combined decoration, comprising (in particular, formed by) the first pattern M1 and the second manipulated pattern M2 created on the printing substrate 2 during the first printing step and the second printing step, and estimates data on the position and orientation of said combined decoration; and during the controlling step, the control unit 13 controls the activation of the printing system 23 also on the basis of the data on the position and orientation of the combined decoration so that the printing system 23 creates on the printing substrate 2 the aforementioned further manipulated pattern M3 configured and arranged with respect to the first pattern MI so as to define together with at least the first pattern M1 and the second manipulated pattern M2 the aforementioned defined decoration.

According to some advantageous but non-limiting embodiments, the surface decoration method also comprises an calibration step, prior to the first printing step and the inspection step. Even more advantageously but not necessarily, this calibration step is implemented on a one-off basis for the setting of the method (in particular, of the decoration apparatus 1 with which this decoration method is implemented).

More advantageously but not necessarily during this calibration step a printing substrate 2 is fed to the first printing station 5; where the printing system 8 creates a test pattern on the printing substrate 2; at this point the printing substrate 2 having this test pattern is laid (manually or automatically) on the conveyor assembly 4 upstream of the inspection station 7 arranged crosswise to said conveying direction A (in particular, orthogonally to the conveying direction A; more in particular, with at least an edge of the printing substrate 2 arranged orthogonally to the conveying direction A); the conveyor assembly 4 conveys the printing substrate 2 having the test pattern and leads it into the inspection station 7; the inspection system 10 captures at least an image of this test pattern present on the printing substrate 2 and estimates data on the position and the orientation of this test pattern; and the control unit 13 processes a correlation function between a reference system used by the printing system 8 while printing the test pattern and a reference system used by the inspection system 10 during the inspection.

In particular, advantageously but not necessarily, position and orientation data, i.e., the X and Y coordinates of the test pattern made on the printing substrate 2 and the orientation θ of this test pattern relative to the conveying direction A, are determined during this calibration step, and such position and orientation data are then set as offset data of the inspection system 10 relative to the position of the printing device 8 located upstream of this inspection system.

In accordance with a further aspect of the present Invention, a Method Is Provided for Manufacturing Ceramic products 28; in particular, ceramic slabs or tiles. This method comprises a method for surface decoration according to the third aspect of the present invention and comprises a firing step, which is subsequent to the printing step and during which the printing substrate 2 is sintered in order to obtain the ceramic product 28.

According to some non-limiting embodiments, the method of manufacturing ceramic products 28 also comprises a compacting step, which is prior to the decoration step and during which a powdered material CP comprising ceramic powder is compacted to form a compacted powder layer KP.

Advantageously, but not necessarily, the method for manufacturing ceramic products 28 is implemented by the plant 27 for manufacturing ceramic products 28 described above (in accordance with the second aspect of the present invention).

The present invention has many advantages, including the following.

The method and the surface decoration apparatus 1 of the present invention enable the different printing systems 8, 9 and 23 to be synchronised automatically and without any need for mechanical centring, taking into account the actual position and orientation of the pattern M1 already created by the printing system 8 for the activation of the subsequent printing systems 9, 23. In this way, perfectly coordinated patterns M1, M2, M3 can be created regardless of the absolute position of the printing substrate 2 relative to the conveyor assembly 4.

Furthermore, the method and the surface decoration apparatus 1 of the present invention, due to the presence of the above-described inspection system 10 ensure that the various patterns M1, M2, M3 are created by the various printing systems 8, 9, 23 guaranteeing levels of precision in the synchronisation/coordination between these patterns M1, M2, M3 comparable to the levels of precision with which the various printing systems 8, 9, 23 operate.

1. A surface decoration apparatus to create a defined decoration on a printing substrate made of a ceramic material; the surface decoration apparatus comprises:
a conveyor assembly to convey said printing substrate along a given path, in a conveying direction, through at least a first printing station, a second printing station, which is arranged downstream of the first printing station, and an inspection station, which is arranged upstream of said second printing station;
a first printing system, which is arranged at said first printing station and is configured to create a first pattern on said printing substrate;
a second printing system, which is arranged at said second printing station;
an inspection system, which is arranged at said inspection station and is configured to capture at least an image of said first pattern created on said printing substrate and to estimate data on the position and the orientation of said first pattern created on the printing substrate; and
a control unit configured to operate said second printing system based on said position and orientation data of said first pattern, so that said second printing system creates, on said printing substrate, a second manipulated pattern to define said defined decoration;
said inspection system being configured to determine the coordinates of said first pattern created on said printing substrate with respect to a fixed reference system which is integral with said inspection system and the orientation of said first pattern with respect to said conveying direction with an accuracy of at least about ±0.6 mm for the coordinates and ±0.1° for said orientation.

2. The surface decoration apparatus according to claim 1, wherein said control unit is configured to rotate and/or translate a second reference pattern, based on said position and orientation data of said first pattern, so as to obtain said second manipulated pattern.

3. The surface decoration apparatus according to claim 1, wherein said inspection system comprises a CIS (Contact Image Sensor) sensor or a CCD (Charged Coupled Device) sensor or a CMOS (Complementary metal-oxide Semiconductor) sensor.

4. The surface decoration apparatus according to claim 1, wherein said inspection system comprises: a lighting unit configured to emit a light beam towards at least an inspection area of said conveyor assembly so as to light said first pattern created on said printing substrate, when the latter goes through said inspection station; an acquisition unit, which is configured to acquire images of said first pattern created on said printing substrate; and a processing unit, which receives the images acquired by said acquisition unit and, based on these images, estimates said position and orientation data of said first pattern created on said printing substrate with respect to the fixed reference system.

5. The surface decoration apparatus according to claim 4, wherein said processing unit is configured to determine the position of a plurality of points of said first pattern relative to said fixed reference system and the orientation of said first pattern relative to said conveying direction.

6. The surface decoration apparatus according to claim 4, wherein said lighting unit comprises a plurality of light sources, which substantially extend crosswise to said conveying direction so as to emit a plurality of light beams towards said conveyor assembly, and a plurality of collimation lenses to collimate said light beams towards said inspection area, which has a main dimension extending crosswise to said conveying direction.

7. The surface decoration apparatus according to claim 1, comprising a detection device, which is arranged upstream of said inspection station along said given path, is configured to detect the presence of said printing substrate and is connected to said inspection system so as to transmit an activation signal to said inspection system every time it detects a printing substrate.

8. The surface decoration apparatus according to claim 1, wherein:
one of said first printing system and said second printing system comprises a digital inkjet printer configured to apply a first material on said printing substrate according to said first pattern or said second manipulated pattern; and
the other one of said first printing system and said second printing system comprises a digital deposition assembly, which is configured to deposit, in a controlled manner, a second material on said printing substrate according to said first pattern or said second pattern.

9. The surface decoration apparatus according to claim 1, wherein said first printing system comprises: a deposition assembly, which is configured to deposit, in a controlled manner, a first material on said printing substrate, and a spraying application unit, which is arranged downstream of said deposition assembly along said given path, to apply, through spraying, a second material on said printing substrate, so that, in contact with the first material, it defines said first pattern; and
the second printing system comprises a further deposition assembly, which is configured to deposit, in a controlled manner, a third material on said printing substrate, or a digital inkjet printer, which is configured to apply a third material on said printing substrate.

10. The surface decoration apparatus according to claim 1, comprising a third printing system arranged in the area of a third printing station, downstream of said second printing station along said given path;
the control unit being configured to also control said third printing system, based on said position and orientation data of said first pattern, so that said third printing system creates, on said printing substrate, a third manipulated pattern to define together with the first pattern and said second manipulated pattern said defined decoration.

11. The surface decoration apparatus according to claim 10, comprising a further inspection system, which is arranged at a further inspection station arranged upstream of said third printing station and downstream of said second printing station along said given path and is configured to acquire at least an image of a combined decoration comprising said first pattern and said second manipulated pattern created on said printing substrate by said first and second printing systems and to estimate data on the position and the orientation of said combined decoration created on said printing substrate;
the control unit being configured to operate said third printing system also based on said position and orientation data of said combined decoration detected by said further inspection system, so that said third printing system creates, on said printing substrate, a third manipulated pattern in order to define, at least together with the first pattern and the second manipulated pattern, said defined decoration.

12. A surface decoration method to create a defined decoration on a printing substrate made of a ceramic material; the decoration method comprises:
a conveying step, during which a conveyor assembly conveys at least one printing substrate along a given path, in a conveying direction, through at least a first printing station, at least a second printing station, which is arranged downstream of the first printing station along the given path, and an inspection station, which is arranged upstream of said second printing station along the given path;
a first printing step, during which a first printing system, which is arranged at said first printing station, creates a first pattern on said printing substrate, while the latter advances at the first printing station;
an inspection step, which is at least partially subsequent to said first printing step and during which an inspection system, which is arranged at said inspection station, acquires at least an image of said first pattern created on said printing substrate and estimates data on the position and the orientation of said first pattern;
at least a second printing step, which is at least partially subsequent to said inspection step and during which a second printing system, which is arranged at said second printing station, creates a second manipulated pattern on said printing substrate; and
a controlling step, which is at least partially subsequent to said inspection step and simultaneous with said second printing step and during which the control unit controls the activation of said second printing system based on the position and orientation data of said first pattern, so that said second printing system creates, on said printing substrate, said second manipulated pattern in order to define, at least together with the first pattern, said defined decoration;
wherein, during said inspection step, said inspection system determines the coordinates of said first pattern created on said printing substrate with respect to a fixed reference system which is integral with said inspection system and the orientation of said first pattern with respect to said conveying direction with an accuracy of at least about ±0.6 mm for the coordinates and ±0.1° for said orientation.

13. The decoration method according to claim 12, wherein said controlling step comprises a manipulation sub-step, during which said control unit rotates and/or translates a second reference pattern based on said position and orientation data of said first pattern and obtains said second manipulated pattern.

14. The decoration method according to claim 12, wherein said inspection step comprises:
a lighting sub-step, during which a lighting unit emits a light beam towards at least an inspection area of said conveyor assembly and it lights said first pattern created on said printing substrate during said first printing step; an image acquiring step, during which a acquisition unit acquires images of said first pattern created on said printing substrate; and
a processing sub-step, during which a processing unit receives the images acquires by said acquisition unit and, based on said images, estimates the position of a plurality of points of said first pattern relative to a fixed reference system and the orientation of said first pattern relative to said conveying direction.

15. The decoration method according to claim 12, or 14, comprising a triggering step, which is at least partially prior to said inspection step and during which a detection device, which is arranged upstream of said inspection station along said given path, detects the presence of said printing substrate and transmits an activation signal to said inspection system.

16. The decoration method according to claim 12, comprising a further printing step, during which a third printing system applies a third manipulated pattern on the printing substrate;
during said controlling step, said control unit controls the activation of said third printing system, based on the position and orientation data of said first pattern, so that said third printing system creates, on said printing substrate, said third manipulated pattern in order to define, together with the first pattern and the second manipulated pattern, said defined decoration.

17. The decoration method according to claim 16, comprising a further inspection step, which is at least partially prior to said third printing step and subsequent to said second printing step and during which a further inspection system, which is arranged downstream of said second printing system along said given path, acquires at least an image of said combined decoration comprising said first pattern and said second manipulated pattern created on said printing substrate during said first printing step and said second printing step and estimates data on the position and the orientation of said combined decoration;
during said controlling step, said control unit controls the activation of said third printing system also based on the position and orientation data of said combined pattern, so that said third printing system creates, on said printing substrate, said third manipulated pattern configured and arranged, relative to said first pattern, so as to define, at least together with the first pattern and the second manipulated pattern, said defined decoration.

18. The decoration method according to claim 12, comprising a calibration step, which is prior to said first printing step and to said inspection step and during which: a printing substrate is fed to said first printing station; said first printing system creates a test pattern on said printing substrate; said printing substrate having said test pattern is laid on said conveyor assembly upstream of said inspection station arranged crosswise to said conveying direction; said conveyor assembly conveys the printing substrate having said test pattern and leads it into said inspection station; said inspection system captures at least an image of said test pattern present on said printing substrate and estimates data on the position and the orientation of said test pattern; and said control unit processes a correlation function between a reference system used by said first printing system while printing said test pattern and a reference system used by said inspection system during the inspection of said test pattern.
